(19) United States
(12) Patent Application Publication
(10) Pub. No.: US 2025/0002200 A1
(43) Pub. Date: Jan. 2, 2025

(54) DEVICE FOR APPLICATION OF A LABEL TO A HOT SURFACE

(71) Applicant: POLYONICS, INC., Westmoreland, NH (US)

(72) Inventors: Michael Secord, West Chesterfield, NH (US); Robert H. Guyette, JR., Sullivan, NH (US); Sarah Brochu, Keene, NH (US); Joyce Bemis, Keene, NH (US); Cody Chase, Walpole, NH (US); Robert J. Koning, Keene, NH (US)

(21) Appl. No.: 18/529,491

(22) Filed: Dec. 5, 2023

Related U.S. Application Data
(60) Provisional application No. 63/510,469, filed on Jun. 27, 2023.

(51) Int. Cl. B65C 9/26; B23Q 3/15

(52) U.S. Cl. CPC B65C 9/262; B23Q 3/15; B65C 2201/00

(57) ABSTRACT

A device for applying a material to a surface includes a handle, a base connected to a distal end of the handle, and a tool assembly. The handle defines a longitudinal axis. The tool assembly includes a support member affixed to the base, an attachment mechanism, and an actuator or a magnetic plate. The attachment mechanism includes at least one plate configured to secure the material to the tool assembly. The actuator or magnetic plate is configured to enable the attachment mechanism to secure the material to the tool assembly during operation of the device.

### CROSS REFERENCE TO RELATED APPLICATIONS

The present application claims the benefit of and priority to U.S. Provisional Patent Application No. 63/510,469, filed on Jun. 27, 2023, the entire contents of which are hereby incorporated by reference in entirety. 3084-6NON

### TECHNICAL FIELD

The present disclosure generally relates to application of a material (e.g., a label) to an elevated temperature surface. More specifically, the present disclosure relates to a device and method for applying a label conveying information to a surface of an object (e.g., a piece of metal), which is at an elevated temperature.

### BACKGROUND

Unless otherwise indicated herein, the materials described in this section are not prior art to the claims herein and are not admitted as being prior art by inclusion in this section. A label is generally a printed piece of paper, plastic, and/or other material, which adheres to an object to convey information about it. The label may be blank or may have a printed image on its face, and may need to be placed onto a surface to identify an object. For example, during metal processing, a label may need to be applied to an object at ambient, slightly elevated (SE), or extremely elevated (EE) temperature. On a production line, tracking the metal processing early in the manufacturing process provides confidence that the labeled object is correctly identified.

Traditional devices and methods for labeling objects include solid paint crayons, chalks, nail guns, hand applications, robotic applications, and/or tamp style applications. However, such devices and methods are often physically and financially intensive due to various customized parts and redundancy costs. Further, these devices and methods may require intimate contact that endangers a user and may result in legibility issues, such as omission of information and/or smearing of print.

Therefore, there exists a need for a simple, safe, and cost-effective device and method for accurately applying a label to a hot surface that greatly reduces or eliminates legibility issues.

### SUMMARY

In accordance with aspects of the present disclosure, a device for applying a material to a surface includes a handle, a base connected to a distal end of the handle, and a tool assembly. The handle defines a longitudinal axis. The tool assembly includes a support member affixed to the base, an attachment mechanism, and an actuator or a magnetic plate. The attachment mechanism includes at least one plate configured to secure the material to the tool assembly. The actuator or magnetic plate is configured to enable the attachment mechanism to secure the material to the tool assembly during operation of the device.

In an aspect of the present disclosure, the material may include a print layer and an adhesive layer.

In another aspect of the present disclosure, the actuator or magnetic plate may be configured to cause attachment of the print layer to the at least one plate or movement of the at least one plate.

In yet another aspect of the present disclosure, the actuator or magnetic plate is configured to transfer the adhesive layer to the surface.

In a further aspect of the present disclosure, the handle may include at least one of a rod or a clip handle.

In yet a further aspect of the present disclosure, the support member may include a first wall and a second wall perpendicular to the longitudinal axis, and a third wall parallel to the longitudinal axis.

In an aspect of the present disclosure, the handle may be fabricated from at least one of stainless steel, aluminum, wood, or plastic.

In another aspect of the present disclosure, the attachment mechanism may include at least one of a plurality of jaw members or a magnet.

In yet another aspect of the present disclosure, the actuator may include at least one of a hand rest ball, a clip handle, or a switch.

In a further aspect of the present disclosure, the base may include a first base portion and a second base portion.

In accordance with aspects of the present disclosure, a device for applying a material to a surface includes a handle defining a longitudinal axis, a base, and a tool assembly. The base includes a first base portion connected to a distal end of the handle and a second base portion. The first base portion extends in a direction perpendicular to the longitudinal axis and the second base portion extends in a direction parallel to the longitudinal axis. The tool assembly includes a support member affixed to the base, an attachment mechanism, and an actuator configured to enable the attachment mechanism to secure the material to the tool assembly during operation of the device. The support includes a plurality of walls, a roller configured to thread the material thereon, and a pin connecting the roller to the plurality of walls. The roller includes at least one recess and a plurality of edges configured to contact at least one edge of a print layer of the material. The attachment mechanism includes first and second jaw members configured to secure the material to the tool assembly. Actuation of actuator causes the first jaw member and the second jaw member to spread apart, allowing placement of the material therebetween.

In an aspect of the present disclosure, the material may include a print layer and an adhesive layer.

In another aspect of the present disclosure, a center of the print layer may be configured to be suspended above the at least one recess of the roller to prevent the plurality of edges from smudging the center of the print layer.

In yet another aspect of the present disclosure, actuation of the actuator may further cause the device to mate the first jaw member and the second jaw member together to secure the material therebetween.

In a further aspect of the present disclosure, the actuator is a hand rest ball, and the first and second jaw members are configured to extend outwards in opposing directions perpendicular to the longitudinal axis.

In yet a further aspect of the present disclosure, the actuator may be a clip handle, and the first and second jaw members may be configured to extend axially in opposing directions.

In accordance with aspects of the present disclosure, a device for applying a material to a surface includes a handle defining a longitudinal axis, a base, and a tool assembly. The base includes a first base portion connected to a distal end of the handle, a second base portion, and a power source. The tool assembly includes a support member affixed to the base, an attachment mechanism, and an actuator configured to enable the attachment mechanism to secure the material to the tool assembly during operation of the device. The attachment mechanism includes at least one magnet configured to secure the material to the tool assembly. Actuation of actuator causes magnetic attachment of the material to the at least one magnet.

In an aspect of the present disclosure, the material may include a print layer, an adhesive layer, and a plurality of ferromagnetic particles arranged along at least one edge of the print layer. The at least one magnet may be configured to adhere to the at least one edge of the print layer to prevent the at least one magnet from smudging a center of the print layer.

In another aspect of the present disclosure, the at least one magnet may be an electromagnet driven by the power source.

In yet another aspect of the present disclosure, the actuator may be a switch configured to turn the power source on and off.

Further details and aspects of exemplary aspects of the present disclosure are described in more detail below with reference to the appended figures.

### BRIEF DESCRIPTION OF THE FIGS.

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

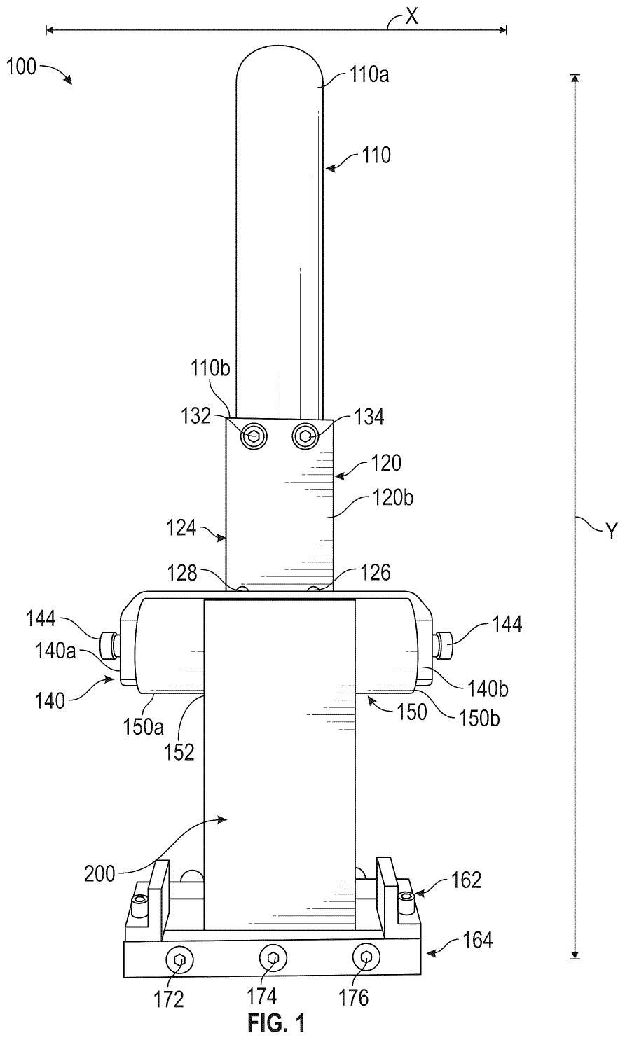

FIG. 1 is a bottom view of a mechanical roller in accordance with the present disclosure;

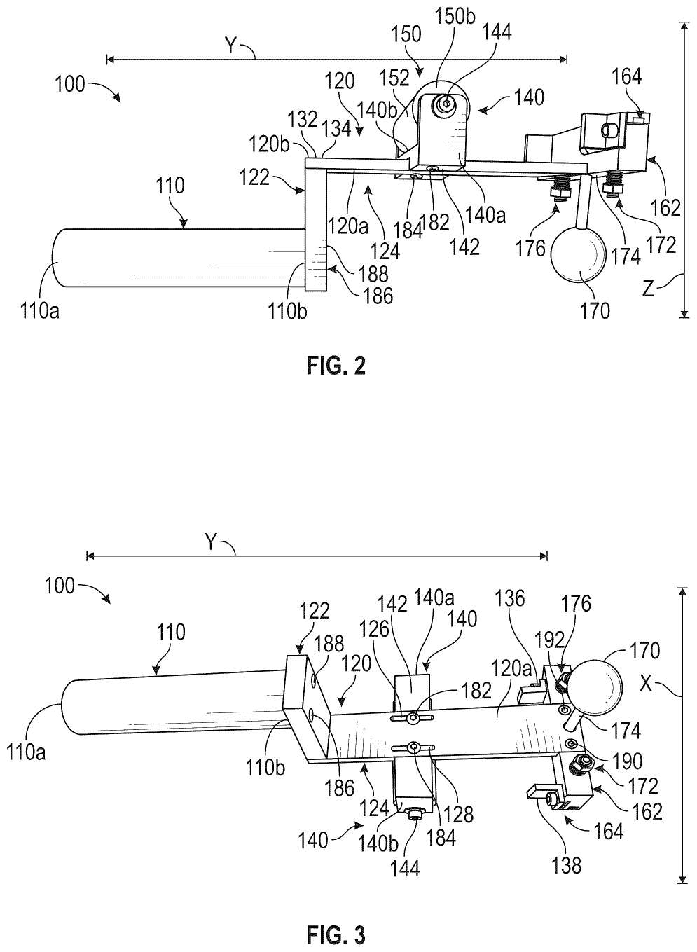

FIG. 2 is a side perspective view of a mechanical roller in accordance with the present disclosure;

FIG. 3 is a top perspective view of a mechanical roller in accordance with the present disclosure;

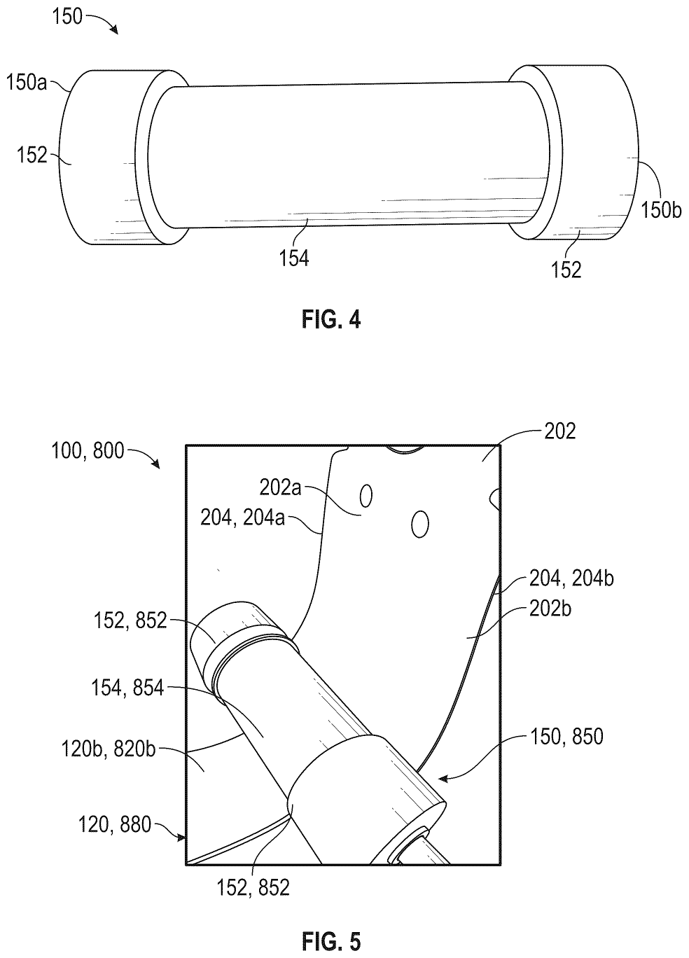

FIG. 4 is a side perspective view of a roller in accordance with the present disclosure;

FIG. 5 is a side perspective view of a roller in accordance with the present disclosure;

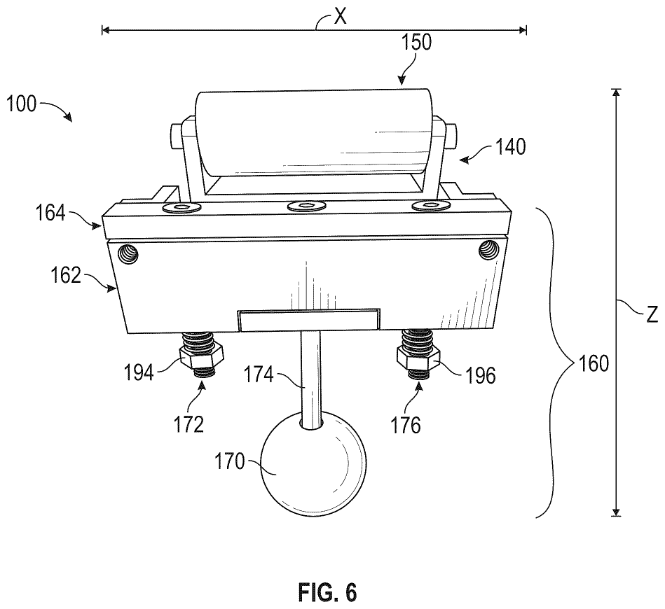

FIG. 6 is a side perspective view of a tool assembly in a first position, in accordance with the present disclosure;

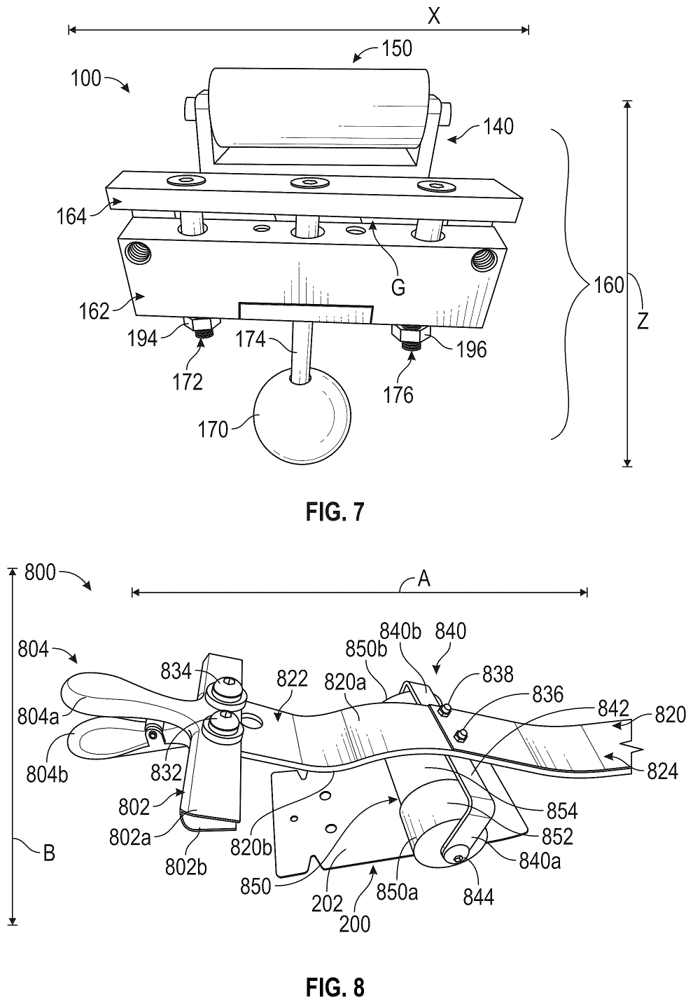

FIG. 7 is a side perspective view of the tool assembly in a second position, in accordance with the present disclosure;

FIG. 8 is a side perspective view of a mechanical roller in accordance with the present disclosure;

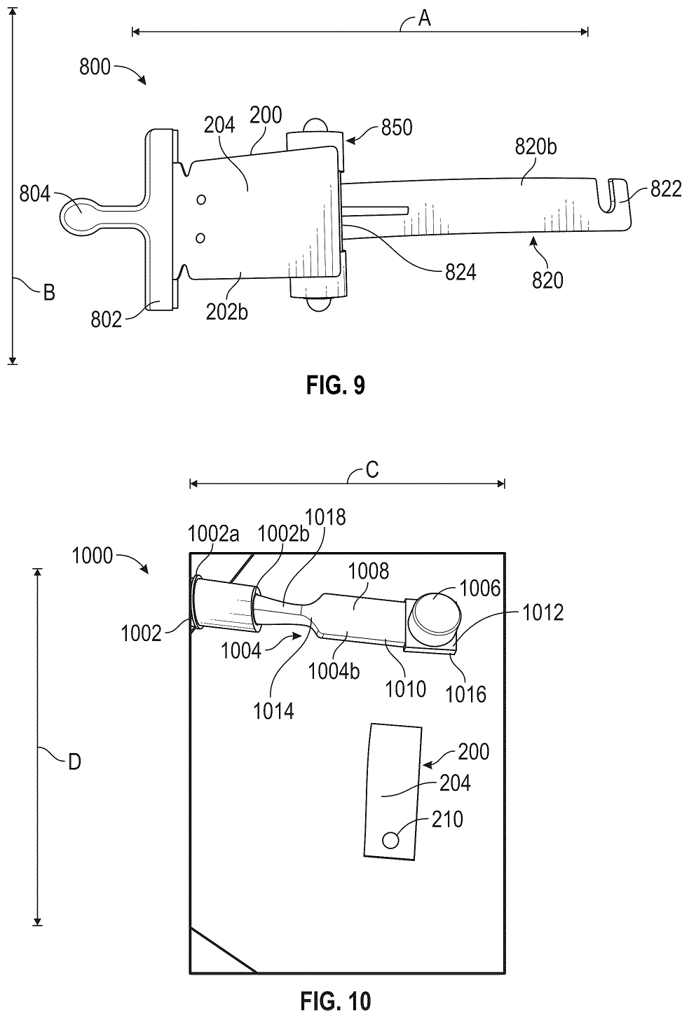

FIG. 9 is a bottom perspective view of a mechanical roller in accordance with the present disclosure;

FIG. 10 is a bottom perspective view of a magnetic applicator in accordance with the present disclosure;

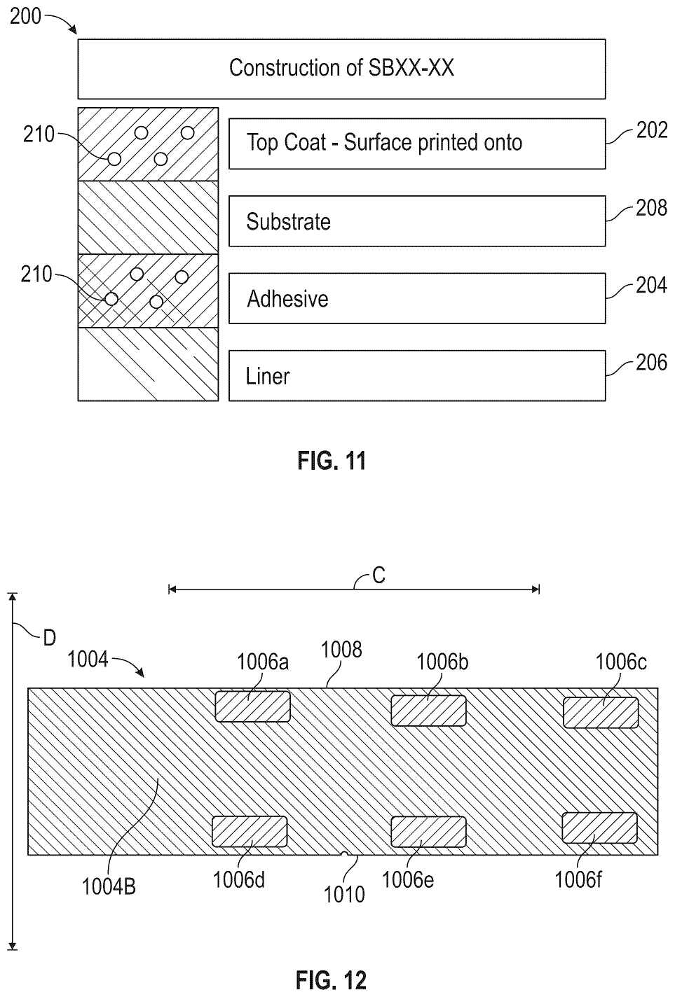

FIG. 11 is a bottom view of a base including magnets, in accordance with the present disclosure;

FIG. 12 illustrates a diagram for an exemplary construction of a material in accordance with the present disclosure;

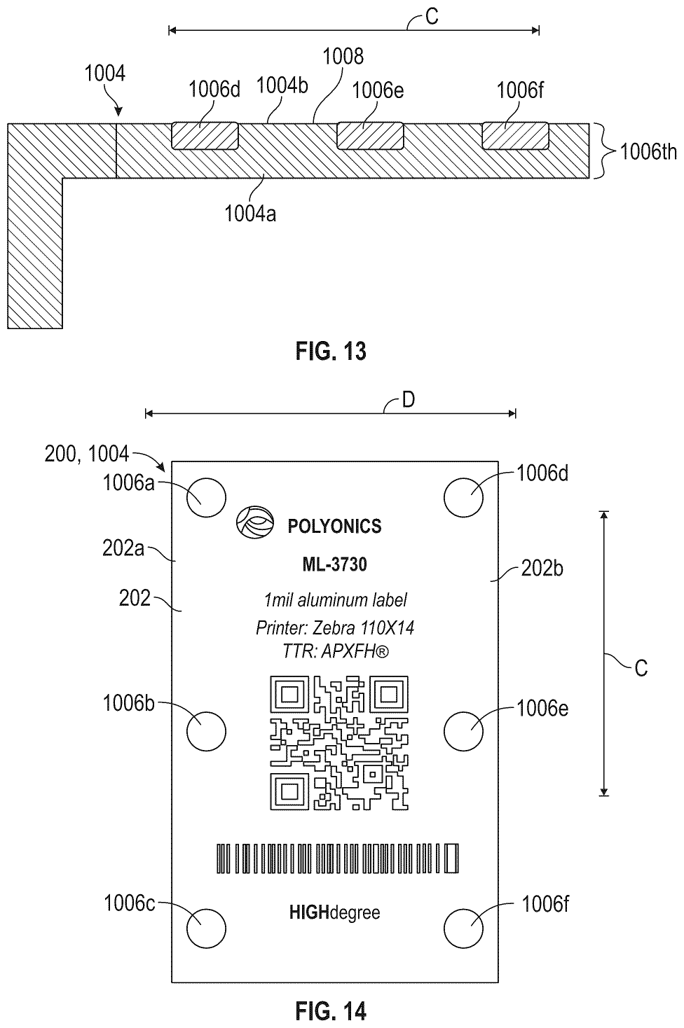

FIG. 13 is a side view of a base including magnets, in accordance with the present disclosure;

FIG. 14 illustrates exemplary placements of magnets on a material, in accordance with the present disclosure;

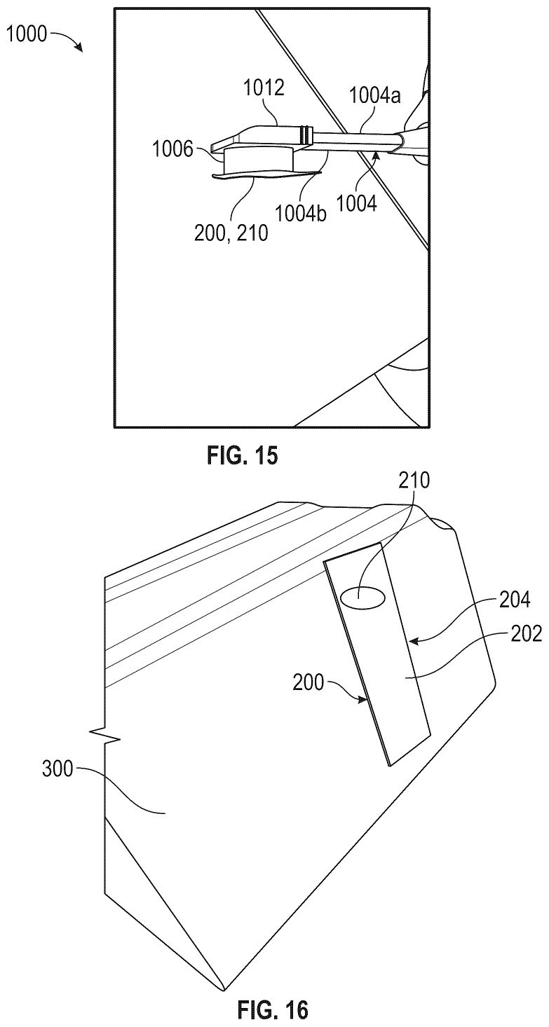

FIG. 15 is a side perspective view of a magnetic applicator in accordance with the present disclosure;

FIG. 16 illustrates exemplary placement of a material on a surface in accordance with the present disclosure;

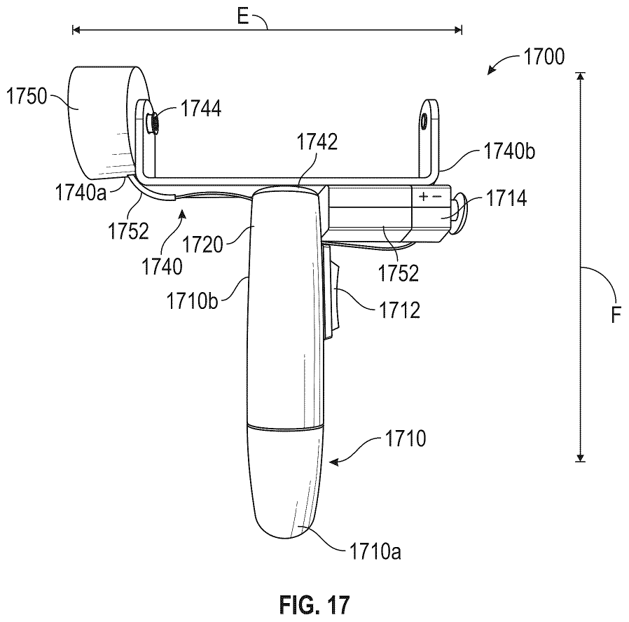

FIG. 17 is a side perspective view of an electromagnetic applicator in accordance with the present disclosure;

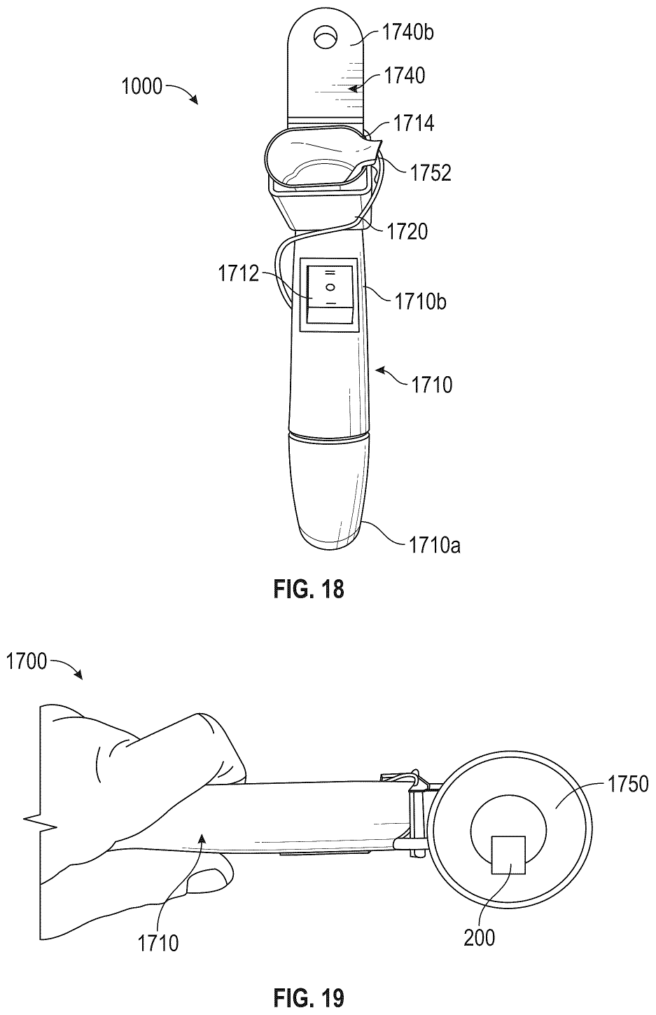

FIG. 18 is a side view of an electromagnetic applicator in accordance with the present disclosure; and

FIG. 19 is a side view of an electromagnetic applicator in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The devices and methods disclosed herein may be used to apply a material such as a label to a surface of an object. While the disclosure describes applying a label to a hot surface, it will be understood that the devices and methods herein may be used to apply a material to a variety of surfaces at various temperatures (e.g., an ambient, slightly elevated (SE), and/or an extremely elevated (EE) temperature).

FIG. 1 is a bottom view of a mechanical roller, arranged in accordance with at least some embodiments described herein. Mechanical roller 100 may include a handle 110, a base 120, a support 140, a roller 150, and a tool assembly 160. Handle 110 may extend distally towards base 120, defining an axis Y. Support 140 may extend horizontally in a direction perpendicular to axis Y, defining an axis X.

Handle 110 may include a proximal end 110a and a distal end 110b. Handle 110 may be fabricated from a metal such as stainless steel or aluminum, although other metals, plastics, and/or composites are contemplated. While handle 110 may have a circular cross section, other shapes are contemplated. Handle 110 may be connected to the base 120 by distal end 110b. In an embodiment, handle 110 may enable a user to grasp mechanical roller 100. For example, handle 110 may include a grip (not shown) to assist the user in grasping handle 110 and/or to provide a heat-resistant surface to hold mechanical roller 100. The grip may include a rubber lining and/or embossed texture to prevent slippage of the user's hand.

FIG. 2 is a side perspective view of a mechanical roller, arranged in accordance with at least some embodiments described herein.

As previously described, handle 110 may be connected to base 120. Base 120 may include an outer surface 120a, an inner surface 120b, a first base portion 122, and a second base portion 124. Base 120 may be fabricated from the same material as handle 110, such as stainless steel or aluminum, although various metals, plastics, composite materials, woods, and/or alternative materials are contemplated. First base portion 122, second base portion 124, and handle 110 may be formed from a single component, or may be coupled together by welding, crimping, gluing, fastening (not shown), or any other suitable method.

Inner surface 120b of first base portion 122 may include fasteners 186, 188, which attach first base portion 122 to handle 110. Inner surface 120b of second base portion 124 may include fasteners 132, 134 (shown in FIG. 1), which may attach second base portion 124 to first base portion 122. Fasteners 132, 134, 186, 188 may be screws, such as sheet metal screws, or bolts, such as carriage bolts, but are not limited thereto. Outer surface 120a of first base portion 122 may contact the distal end 110b of handle 110. First base portion 122 may extend upwards in a direction perpendicular to axis Y, defining an axis Z. The second base portion 124 may extend in a direction parallel to axis Y. In aspects, first base portion 122 may be shorter in length than second base portion 124. First base portion 122 and second base portion 124 are shown as rectangular-shaped blocks, forming an L-shape of base 120, although alternative shapes and/or configurations are envisioned.

Support 140 may include first support end portion 140a, second support end portion 140b, top support portion 142, and pin 144. First support end portion 140a and second support end portion 140b may extend upwards from second base portion 124 in a direction parallel to axis Z (e.g., direction of first base portion 122). Top support portion 142 may extend in a direction parallel to axis X (FIG. 1). Together, first support end portion 140a, second support end portion 140b, and top support portion 142 may form a U shape, with each individual portion being rectangularly shaped, although various shapes/configurations are envisioned. First support end portion 140a, second support end portion 140b, and top support portion 142 may be formed as a single component or may be multiple components coupled together.

Similar to handle 110 and base 120, the components of support 140 may be fabricated from stainless steel, although various metals, plastics, composite materials, and/or alternative materials are contemplated. First support end portion 140a and second support end portion 140b may be connected by pin 144. Pin 144 may be inserted into roller 150, such that roller 150 is connected to support 140. In use, roller 150 may rotate about pin 144.

FIG. 3 is a top perspective view of a mechanical roller, arranged in accordance with at least some embodiments described herein.

Slots 126, 128 may be defined by second base portion 124. Second base portion 124 may be affixed to tool assembly 160 by fasteners 190, 192. Support 140 may be affixed to second base portion 124 by fasteners 182, 184 (FIG. 3). Fasteners 182, 184, 190, 192 may be screws, such as sheet metal screws, or bolts, such as carriage bolts, but are not limited thereto. Fasteners 182, 184 may be connected to top support portion 142 through slots 126, 128, such that support 140 may slidably engage with base 120.

FIG. 4 is a side perspective view of a roller, arranged in accordance with at least some embodiments described herein.

As previously described, roller 150 may be connected to support 140. Roller 150 may include a first roller end portion 150a and a second roller end portion 150b. Roller 150 may be configured with roller edges 152 and roller relief 154. Roller edges 152 may have a diameter greater in size than a diameter of roller relief 154, and roller relief 154 may form a recessed portion of roller 150. Roller 150 may have a circular cross section to facilitate rotation about pin 144. Generally, roller 150 is fabricated from a heat resistant material, such as stainless steel or aluminum, although various alternative materials are contemplated.

FIG. 5 is a side perspective view of a roller, arranged in accordance with at least some embodiments described herein.

Mechanical roller 100 may be configured to apply a material 200 (e.g., a label) onto a surface, such as a hot surface (e.g., slightly elevated or extremely elevated temperature). Material 200 may include a print layer 202 configured to display information (e.g., image, barcode, and/or serial number), and an adhesive layer 204 configured to adhere to a surface. Print layer 202 may include edges 202a, 202b. Adhesive layer 204 may include edges 204a, 204b.

Roller 150 may be configured to interact with material 200 such that during application of pressure by a user, material 200 may be threaded around roller 150. In doing so, material 200 may contact roller edges 152, while avoiding contact with roller relief 154 and thus preventing smudging of print layer 202.

FIG. 6 is a side perspective view of a tool assembly in a first position, and FIG. 7 is a side perspective view of a tool assembly in a second position, arranged in accordance with at least some embodiments described herein.

Tool assembly 160 may include a first jaw member 162, a second jaw member 164, and hand rest ball 170 (i.e., actuator). First jaw member 162 may be connected to second jaw member 164 by connectors 172, 174, 176. Connectors 172, 174, 176 may be bolts, screws, and/or metal rods, but are not limited thereto. Connectors 172, 174 may include bolts 194, 196 respectively, which may be configured to act as stoppers. In aspects, a portion of tool assembly 160 may be spring-loaded. Connectors 172, 176 may include bolts and springs, which tension second jaw member 164 to first jaw member 162 when pressure is released from and/or pressure is not applied on hand rest ball 170. First jaw member 162 and second jaw member 164 may be rectangularly shaped, extending in a direction parallel to axis X. As shown in FIGS. 6 and 7, first jaw member 162 may be larger in size than second jaw member 164, although varying sizes are contemplated by this disclosure. The tool assembly 160 may include guides 136, 138 (FIG. 3), which may be formed in the first jaw member and/or the second jaw member 164 to provide a guide for aligning the label. For example, guides 136, 138 may be used to keep the label aligned during application and/or while placing the label onto the tool assembly 160 prior to application.

Hand rest ball 170, connector 174, and second jaw member 164 may be mechanically coupled, such that movement of hand rest ball 170 results in movement of second jaw member 164. Specifically, pressure applied to hand rest ball 170 may be transferred to connectors 172, 174, and subsequently to second jaw member 164, pushing second jaw member 164 apart from second jaw member 164. In doing so, second jaw member 164 may extend outwards in a direction parallel to axis Z until bolts 194, 196 reach a bottom surface of first jaw member 162, thereby blocking further movement. Generally, hand rest ball 170 is spherically shaped, although alternative, ergonomic shapes are contemplated, such as a hand rest with grooves shaped to the palm of a hand. The components of tool assembly 160 may be fabricated from stainless steel or aluminum, although various metals, plastics, composite materials, woods, and/or alternative materials are contemplated.

Tool assembly 160 may be configured to hold material 200 by transitioning between a first position (closed position) and a second position (open position). Mechanical roller 100 may be biased towards the first position, in which first jaw member 162 and second jaw member 164 are coupled together when mechanical roller 100 is not in use/pressure is not applied (FIG. 6).

In use, a user may apply pressure to mechanical roller 100 while holding handle 110. Pressure may be transferred to hand rest ball 170, causing first jaw member 162 and second jaw member 164 to spread apart into the second position (FIG. 7). Once in the second position, a user may insert material 200 between first jaw member 162 and second jaw member 164, and/or thread material around roller 150. Once material 200 is placed in a desired position, the user may release pressure on the mechanical roller 100 and hand rest ball 170, reverting mechanical roller 100 back to the first position (FIG. 6). With mechanical roller 100 in the first position, first jaw member 162 and second jaw member 164 will recouple and secure material 200 therebetween.

Once material 200 is secured in tool assembly 160, the user may apply material 200 to a surface. Upon user's application of pressure to handle 110, roller 150 may rotate about pin 144. As roller 150 rotates, roller edges 152 may directly contact edges 202a, 202b of print layer 202 (FIG. 5), causing edges 204a, 204b of adhesive layer 204 to transfer from roller 150 onto the surface. In doing so, only roller edges 152 may contact material 200 (e.g., by a center of print layer 202), preventing information on print layer 202 from smudging.

FIG. 8 is a side perspective view of a mechanical roller, arranged in accordance with at least some embodiments described herein.

Mechanical roller 800 is similar in aspects to mechanical roller 100, and for brevity, primarily the differences will be discussed.

Mechanical roller 800 may include a base 820, a clip base 802, a clip handle 804 (i.e., actuator), a support 840, and a roller 850. Base 820 may extend outwards in a longitudinal direction, defining an axis A. Clip base 802 may extend in a direction perpendicular to axis A, defining an axis B.

Clip base 802 may include a pair of jaws 802a, 802b configured to hold material, such as material 200. Jaws 802a, 802b may be configured to open and/or extend outwards in response to a user applying pressure to clip handle 804. Clip handle 804 may extend from clip base 802. Clip handle 804 may include handles 804a, 804b, which enable a user to open and/or close clip base 802. Clip handle 804 and base 820 may be fabricated from stainless steel or aluminum, although various metals, plastics, composite materials, woods, and/or alternative materials are contemplated.

Base 820 may include an outer surface 820a, an inner surface 820b, a proximal end 822, and a distal end 824. Clip base 802 may be attached to proximal end 822 of base 820 by connectors 832, 834. Support 840 may be attached to base 820 by connectors 836, 838. Connectors 832, 834, 836, 838 may be screws, such as sheet metal and/or support screws, or bolts, such as carriage bolts, but are not limited thereto. Similar to clip handle 804 and clip base 802, base 820 may be fabricated from stainless steel or aluminum, although various metals, plastics, composite materials, woods, and/or alternative materials are contemplated.

Support 840 may extend outwards from inner surface 820b of base 820. Similar to support 140, support 840 may include first support end portion 840a, second support end portion 840b, top support portion 842, and pin 844. Top support portion 842 may extend in a direction parallel to axis B. Together, first support end portion 840a, second support end portion 840b, and top support portion 842 may form a U shape, with each individual portion being rectangularly shaped, although various shapes/configurations are envisioned. First support end portion 840a, second support end portion 840b, and top support portion 842 may be formed from a single component or coupled together. First support end portion 840a and second support end portion 840b may be connected by pin 844. Pin 844 may be inserted into roller 850, such that roller 850 is connected to support 840. In use, roller 850 may rotate about pin 844. The components of support 840 may be fabricated from stainless steel or aluminum, although various metals, plastics, composite materials, and/or alternative materials are contemplated.

Roller 850 may include a first roller end portion 850a and a second roller end portion 850b. In aspects, roller 850 may be configured with roller edges 852, and roller relief 854. Roller edges 852 may have a diameter greater in size than a diameter of roller relief 854, and roller relief 854 may form a recessed portion of roller 850. Roller 850 may have a circular cross section to facilitate rotation about pin 844. Generally, roller 850 is fabricated from a heat resistant material, such as stainless steel or aluminum, although various alternative materials are contemplated.

Mechanical roller 800 may be configured to apply material 200 onto a surface, such as a hot surface (e.g., slightly elevated or extremely elevated temperature). The aspects of material 200 will not be described again for the purposes of brevity. Roller 850 may be configured to interact with material 200 such that during application of pressure by a user, material 200 may be threaded around roller 850. In doing so, material 200 may contact roller edges 852, while avoiding contact with roller relief 854 and thus preventing smudging of print layer 202.

FIG. 9 is a bottom perspective view of a mechanical roller, arranged in accordance with at least some embodiments described herein.

Clip base 802 may be configured to hold material 200 by transitioning between a first position (closed position) and a second position (open position). Mechanical roller 800 may be biased towards the first position, in which jaws 802a, 802b are coupled together when mechanical roller 800 is not in use/pressure is not applied.

In use, a user may hold mechanical roller 800 by clip handle 804 and/or base 820. A user may then apply pressure to handles 804a, 804b, causing jaws 802a, 802b of clip base 802 to spread apart into the second position. Once in the second position, the user may insert material 200 between jaws 802a, 802b, and/or thread material around roller 850. Once material 200 is placed in a desired position, the user may release pressure on handles 804a, 804b, reverting mechanical roller 800 back to the first position. With mechanical roller 800 in the first position, jaws 802a, 802b will recouple and secure material 200 therebetween.

Once material 200 is secured in jaws 802a, 802b, the user may apply material 200 to a surface. Upon user's application of pressure to mechanical roller 800 (e.g., via clip handle 804 and/or base 820), roller 850 may rotate about pin 844. As roller 850 rotates, roller edges 852 may directly contact edges 202a, 202b of print layer 202 (FIGS. 5, 9), causing edges 204a, 204b of adhesive layer 204 to transfer from roller 850 onto the surface. In doing so, only roller edges 852 may contact material 200 (e.g., by a center of print layer 202), preventing information on print layer 202 from smudging.

FIG. 10 is a bottom perspective view of a magnetic applicator, arranged in accordance with at least some embodiments described herein.

A magnetic applicator 1000 may include a handle 1002, a base 1004, a support 1018 and a magnet 1006. Base 1004 may extend outwards in a proximal direction towards handle 1002, defining an axis C. A proximal end of handle 1002 may extend in a direction perpendicular to axis C, defining an axis D.

Handle 1002 may include a proximal end 1002a and a distal end 1002b. Handle 1002 may be fabricated from a metal such as stainless steel or aluminum, although other metals, plastics, composites, woods, and/or alternative materials are contemplated. While handle 1002 is shown as having a conical shape and/or a circular cross section, other configurations are contemplated. Handle 1002 may be connected to base 1004 by distal end 1002b. In an embodiment, handle 1002 may enable a user to grasp magnetic applicator 1000. For example, handle 1002 may include a grip (not shown) to assist the user in grasping handle 1002 and/or to provide a heat-resistant surface to hold magnetic applicator 1000. The grip may include a rubber lining and/or an embossed texture to prevent slippage of the user's hand.

Base 1004 may include an outer surface 1004a, an inner surface 1004b, a first edge 1008, a second edge 1010, a proximal end 1014, and a distal end 1016. Distal end 1002b of handle 1002 may be connected to support 1018 and/or proximal end 1014 of base 1004. Base 1004 may be fabricated from the same material as handle 110, such as stainless steel or aluminum, although various metals, plastics, composite materials, woods, and/or alternative materials are contemplated. Base 1004 is shown as having a generally rectangular shape, which tapers into support 1018, which is shown as a slim conical, extension connected to handle 1002. Handle 1002, support 1018, and/or base 1004 may be formed from a single component, or may be coupled together by welding, crimping, gluing, fastening (not shown), or any other suitable method.

Magnet 1006 may be affixed to a distal end of the inner surface 1004b of base 1004. Magnet 1006 may be fabricated from any ferromagnetic/magnetic material, such as iron, cobalt, stainless steel, and/or nickel. For example, magnet 1006 may be a permanent magnet including ferrite, alnico, samarium cobalt, and/or neodymium iron boron. In aspects, magnet 1006 may be removably coupled to base 1004 by a magnetic plate 1012. In aspects, magnetic plate 1012 may be a magnetized metal plate configured to magnetically couple to magnet 1006 and/or base 1004. Other, permanent methods of fixation for coupling magnet 1006 to base 1004 (e.g., welding, crimping, gluing, and/or fastening) are also contemplated. In aspects, magnetic plate 1012 may be substituted for a non-magnetized plate (e.g., steel plate that magnet 1006 may be welded onto).

FIG. 11 illustrates a diagram for an exemplary construction of a material with ferromagnetic particles, arranged in accordance with at least some embodiments described herein.

Magnetic applicator 1000 may be configured to apply a material 200 incorporated with ferromagnetic particles 210 onto a surface, such as a hot surface (e.g., slightly elevate or extremely elevated temperature). Material 200 may include print layer 202 (e.g., a topcoat), a substrate layer 208, adhesive layer 204, and/or a liner 206. Material 200 may be configured for magnetic coupling to magnet 1006. For example, ferromagnetic particles 210 may be included in layers of material 200, such as adhesive layer 204 and/or print layer 202. In aspects, ferromagnetic particles 210 may include iron oxide. Ferromagnetic particles may be dispersed throughout layer(s) of material 200 or only on edges thereof (e.g., edges 202a, 202b, 204a, 204b). When a sufficient concentration of ferromagnetic particles 210 is paired with a magnetic strength of magnet 1006, magnet 1006 may adhere to and/or lift material 200 (e.g., a coated film material). For example, a stronger magnet may require less ferromagnetic particles 210.

Print layer 202 may include a surface formulation configured for printing images thereon. For example, print layer 202 may include a surface fabricated from a heat transfer material (i.e., “thermal transfer printable”) such as silicone, polyester, epoxy, polyurethane, and/or other materials. Substrate layer 208 may be fabricated from thermoplastics, such as polyimide, and/or metals, such as aluminum or stainless steel. Adhesive layer 204 may be fabricated from a pressure sensitive adhesive, such as an acrylic, and/or a dry adhesive, such as a polyimide resin that dries to a film (e.g., Skybond® 705), or silicone, and/or other materials. Liner 206 may be fabricated from fabric, plastic, paper, or any other suitable material. Liner 206 is configured to cover and/or protect adhesive layer 204 from exposure. In aspects, liner 206 may be an optional layer of material 200, which may be required based on the formulation of the preceding layers. For example, a liner 206 may be included when adhesive layer 204 includes pressure-sensitive adhesive, which may prevent transfer of adhesive substances onto print layer 202 when material 200 is rolled up for transportation and/or storage.

FIG. 12 is a bottom view of a base including magnets, and FIG. 13 is a side view of a base including magnets, arranged in accordance with at least some embodiments described herein.

Multiple magnets 1006 may be arranged on base 1004, in a variety of patterns and/or configurations. As shown in FIG. 12, three magnets 1006a, 1006b, 1006c may be arranged horizontally along first edge 1008 of inner surface 1004b, parallel to axis C. Three magnets 1006d, 1006e, 1006f may be arranged along second edge 1010 of inner surface 1004b, parallel to axis C. Magnets 1006a, 1006b, and 1006c may include one row, and magnets 1006d, 1006e, and 1006f may include a second row, both parallel with axis C, such that 1006a and 1006d are aligned horizontally, 1006b an 1006e are aligned horizontally, and 1006e and 1006f are aligned horizontally along an axis D perpendicular to axis C. It will be understood that the disclosed arrangement is exemplary, and various numbers and/or arrangements of magnets are contemplated.

As shown in FIG. 13, base 1004 may have a thickness of 1006th. For example, base 1004 may be between about 3-26 mm thick. Magnets 1006a, 1006b, 1006c, 1006d, 1006e, 1006f may have a thickness that is smaller than base thickness 1006th, such that material 200 may be adhered closely to base 1004 when connected to any of magnets 1006a, 1006b, 1006c, 1006d, 1006e, 1006f. It will be understood that the disclosed arrangement is exemplary, and base 1004 and/or magnets 1006a, 1006b, 1006c, 1006d, 1006e, 1006f may be configured in a variety of shapes and sizes.

FIG. 14 illustrates exemplary placements of magnets on a layer of a material, arranged in accordance with at least some embodiments described herein.

Magnets 1006a, 1006b, 1006c, 1006d, 1006e, 1006f may be arranged on base 1004 in relation to print layer 202 of material 200. For example, magnets 1006a, 1006b, 1006c, 1006d, 1006e, 1006f, when arranged on base 1004, may be superimposed over edges 202a, 202b of print layer 202. In doing so, magnets 1006a, 1006b, 1006c, 1006d, 1006e, 1006f may be configured as to only contact with the edges 202a, 202b of print layer 202, which may avoid smudging of printing on material 200.

FIG. 15 is a side perspective view of a magnetic applicator, arranged in accordance with at least some embodiments described herein.

Magnetic applicator 1000 may be configured to hold material 200. In use, a user may grasp handle 1002 and position inner surface 1004b downwards to face material 200 (e.g., print layer 202). Next, the user may line up magnet(s) 1006 with the edges 202a, 202b of print layer 202. An arrangement of ferromagnetic particles 210 throughout material 200 (e.g., in print layer 202 and/or adhesive layer 204) may enable magnet(s) 1006 to pick up and subsequently secure material 200 to magnetic applicator 1000.

FIG. 16 illustrates exemplary placement of a material on a surface by a magnetic applicator, arranged in accordance with at least some embodiments described herein.

Once material 200 is secured to magnetic applicator 1000, the user may apply material 200 to a surface 300, such as a hot surface (e.g., slightly elevated or extremely elevated temperature). The user may grasp handle 1002 and position inner surface 1004b, including adhesive layer 204, near a desired surface 300. Next, the user may press magnetic applicator 1000 onto the surface 300, causing edges 204a, 204b of adhesive layer 204 to transfer from inner surface 1004b onto surface 300. In doing so, magnet(s) 1006 may only contact material 200 on edges 202a, 202b, 204a, 204b, preventing information on print layer 202 from smudging. In aspects, adhesive layer 204 may be pressure sensitive and may be activated thermally when applied to surface 300.

FIG. 17 is a side perspective view of an electro-magnetic applicator, arranged in accordance with at least some embodiments described herein.

Electromagnetic applicator 1700 is similar in aspects to magnetic applicator 1000, and for brevity, primarily the differences will be discussed.

Electromagnetic applicator 1700 may include a handle 1710, a base 1720, a support 1740, and an electromagnet 1750. Handle 1710 may extend in a longitudinal direction towards base 1720, defining an axis F. Base 1720 and/or support 1740 may extend in a direction perpendicular axis F, defining an axis E.

Handle 1710 may include a first end 1710a and a second end 1710b. Handle 1710 may be fabricated from a metal such as stainless steel or aluminum, although other metals, plastics, composites, woods, and/or alternative materials are contemplated. In aspects, handle 1710 may be fabricated from a nonconductive material, such as wood, rubber, ceramic, and/or plastic. While handle 1710 may have a circular cross section, other shapes are contemplated. Handle 1710 may be connected to base 1720 by second end 1710b. In an embodiment, handle 1710 may enable the user to grasp electromagnetic applicator 1700. For example, handle 1710 may include a grip (not shown) to assist the user in grasping handle 1710 and/or to provide a heat-resistant surface to hold electromagnetic applicator 1700. The grip may include a rubber lining and/or embossed texture to prevent slippage of the user's hand.

Base 1720 may be fabricated from stainless steel or aluminum, although various metals, plastics, composite materials, woods, and/or alternative materials are contemplated. Base 1720 and handle 1710 may be formed from a single component, or may be coupled together by welding, crimping, gluing, fastening (not shown), or any other suitable method. Base 1720 may be the smaller in length than handle 1710. A power source 1714 may be coupled to base 1720.

Support 1740 may include first support end portion 1740a, second support end portion 1740b, and top support portion 1742. Support 1740 may be fabricated from stainless steel or aluminum, although various metals, plastics, composite materials, and/or alternative materials are contemplated. First support end portion 1740a and second support end portion 1740b may extend upwards from base 1720 in a direction parallel to axis F. Top support portion 1742 may extend in a direction parallel to axis E. Together, first support end portion 1740a, second support end portion 1740b, and top support portion 1742 may form a U shape, with each individual portion being rectangularly shaped, although various shapes/configurations are envisioned. First support end portion 1740a, second support end portion 1740b, and top support portion 1742 may be formed from a single component or coupled together.

Support 1740 may be coupled to an electromagnet 1750 by a fastener 1744. Fastener 1744 may be a screw, such as a sheet metal screw, or a bolt, such as a carriage bolt, but is not limited thereto. For example, fastener 1744 may be a magnet configured to couple to electromagnet 1750, securing electromagnet 1750 to support 1740 by a magnetic force. As shown in FIG. 17, electromagnet 1750 may be coupled to first support end portion 1740a, although alternative configurations are envisioned. For example, electromagnet 1750 and/or a second magnet (not shown) may be coupled to second support end portion 1740b, i.e., on a proximal end of electromagnet 1750. In aspects, multiple electromagnets 1750 and/or additional magnets may be arranged along a portion of electromagnetic applicator 1700 (e.g., along support 1740 in rows to align with edges 202a, 202b, 204a, 204b of material 200).

FIG. 18 is a side view of an electromagnetic applicator, arranged in accordance with at least some embodiments described herein.

As previously shown, a power source 1714 may be coupled to base 1720. Power source 1714 may be configured to supply power to electromagnet 1750. In aspects, power source 1714 may be a battery, such as a lithium-ion battery, an alkaline battery, and/or a nick metal hydride battery. For example, power source 1714 may be a 9-volt battery. Power source 1714 may be electrically coupled to electromagnet 1750 by electrical wires 1752. Electrical wires 1752 may be disposed along a length of support 1740 and/or threaded through a channel therein.

A switch 1712 (i.e., actuator) may be affixed to handle 1710. Switch 1712 may be electrically coupled to power source 1714 and/or electromagnet 1750, such that switch 1712 is configured to turn a supply of power to electromagnet 1750 on and off. Switch 1712 may be a single pole switch including an outwardly protruding lever, which may be toggled to connect (e.g., turn on), and disconnect (e.g., turn off) from power source 1714. In aspects, switch 1712 may be a flip switch, rocker switch, three-way switch, four-way switch, and/or another type of switch. In aspects, power source 1714 may include a dial (not shown) configured to alter a strength and/or charge (e.g., positive versus negative) of electricity.

FIG. 19 is a side view of an electromagnetic applicator, arranged in accordance with at least some embodiments described herein.

As previously shown, electromagnet 1750 may be affixed to first support end portion 1740a of support 1740. Electromagnet 1750 may be fabricated from any ferromagnetic/magnetic material, such as iron, cobalt, stainless steel, and/or nickel. While electromagnet 1750 is shown with a circular cross-section, other shapes are envisioned.

Electromagnetic applicator 1700 may be configured to apply material 200 incorporated with ferromagnetic particles 210 onto a surface, such as a hot surface (e.g., slightly elevated or extremely elevated temperature). Electromagnet 1750 may be configured to hold material 200 by transitioning between a first mode (i.e., powered off) and a second mode (i.e., powered on). Electromagnetic applicator 1700 may initially maintain electromagnet 1750 in the first mode, i.e., powered off.

In use, a user may grasp handle 1710 and position electromagnet 1750 downwards to face material 200 (e.g., print layer 202). Next, the user may line up electromagnet 1750 and/or any additional magnets with edges 202a, 202b of print layer 202. Thereafter, the user may turn on power source 1714 by toggling switch 1712, transitioning electromagnet 1750 from the first mode to the second mode. Once entering the second mode, electromagnet 1750 may become electrically charged. An arrangement of ferromagnetic particles 210 throughout material 200 (e.g., in print layer 202 and/or adhesive layer 204) may enable electromagnet 1750 and/or any additional magnets to pick up and subsequently secure material 200 to electromagnetic applicator 1700.

Once material 200 is secured to electromagnet, the user may apply material 200 to a surface, such as surface 300 (FIG. 16). Next, the user may press electromagnetic applicator 1700 onto surface 300, causing edges 204a, 204b of adhesive layer 204 to adhere to surface 300. In doing so, electromagnet 1750 may only contact material 200 on edges 202a, 202b, 204a, 204b, thereby preventing information on print layer 202 from smudging. In aspects, adhesive layer 204 may be pressure sensitive and may be activated thermally when applied to surface 300.

Upon user toggling switch 1712, power source 1714 may cut off power to electromagnet 1750. Electromagnet 1750 may transition from the second mode to the first mode, releasing material 200 and allowing edges 204a, 204b of adhesive layer 204 to remain on surface 300.

Finally, the processes and techniques described herein are not inherently related to any apparatus and may be implemented by any suitable combination of components. Further, various types of general-purpose devices may be used in accordance with the teachings described herein. It may also prove advantageous to construct specialized apparatus to perform the method steps described herein. This disclosure has been described in relation to the examples, which are intended in all respects to be illustrative rather than restrictive.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A device for applying a material to a surface, comprising:
a handle defining a longitudinal axis;
a base connected to a distal end of the handle;
a tool assembly, including:
a support member affixed to the base;
an attachment mechanism including at least one plate configured to secure the material to the tool assembly; and
an actuator or a magnetic plate configured to enable the attachment mechanism to secure the material to the tool assembly during operation of the device.

2. The device of claim 1, wherein the material includes a print layer and an adhesive layer.

3. The device of claim 2, wherein the actuator or magnetic plate is configured to cause attachment of the print layer to the at least one plate or movement of the at least one plate.

4. The device of claim 3, wherein the actuator or magnetic plate is configured to transfer the adhesive layer to the surface.

5. The device of claim 1, wherein the handle includes at least one of a rod or a clip handle.

6. The device of claim 1, wherein the support member includes a first wall and a second wall perpendicular to the longitudinal axis, and a third wall parallel to the longitudinal axis.

7. The device of claim 1, wherein the handle is fabricated from at least one of stainless steel, aluminum, wood, or plastic.

8. The device of claim 1, wherein the attachment mechanism includes at least one of a plurality of jaw members or a magnet.

9. The device of claim 1, wherein the actuator includes at least one of a hand rest ball, a clip handle, or a switch.

10. The device of claim 1, wherein the base includes a first base portion and a second base portion.

11. A device for applying a material to a surface, comprising:
a handle defining a longitudinal axis;
a base including:
a first base portion connected to a distal end of the handle; and
a second base portion,
wherein the first base portion extends in a direction perpendicular to the longitudinal axis, and the second base portion extends in a direction parallel to the longitudinal axis;
a tool assembly, including:
a support member affixed to the base, including:
a plurality of walls;
a roller configured to thread the material thereon, the roller including:
at least one recess; and
a plurality of edges configured to contact at least one edge of a print layer of the material; and
a pin connecting the roller to the plurality of walls;
an attachment mechanism, including:
first and second jaw members configured to secure the material to the tool assembly; and
an actuator configured to enable the attachment mechanism to secure the material to the tool assembly during operation of the device,
wherein actuation of actuator causes the first jaw member and the second jaw member to spread apart, allowing placement of the material therebetween.

12. The device of claim 11, wherein the material includes a print layer and an adhesive layer.

13. The device of claim 12, wherein a center of the print layer is configured to be suspended above the at least one recess of the roller to prevent the plurality of edges from smudging the center of the print layer.

14. The device of claim 11, wherein actuation of the actuator further causes the device to mate the first jaw member and the second jaw member together to secure the material therebetween.

15. The device of claim 11, wherein the actuator is a hand rest ball, and the first and second jaw members are configured to extend outwards in opposing directions perpendicular to the longitudinal axis.

16. The device of claim 11, wherein the actuator is a clip handle, and the first and second jaw members are configured to extend axially in opposing directions.

17. A device for applying a material to a surface, comprising:
a handle defining a longitudinal axis;
a base including:
a first base portion connected to a distal end of the handle;
a second base portion; and
a power source;
a tool assembly, including:
a support member affixed to the base;
an attachment mechanism including at least one magnet configured to secure the material to the tool assembly; and
an actuator configured to enable the attachment mechanism to secure the material to the tool assembly during operation of the device,
wherein actuation of actuator causes magnetic attachment of the material to the at least one magnet.

18. The device of claim 17, wherein the material includes:
a print layer;
an adhesive layer; and
a plurality of ferromagnetic particles arranged along at least one of an edge of the print layer or a surface of the print layer, wherein the at least one magnet is configured to adhere to the print layer to prevent the at least one magnet from smudging a center of the print layer.

19. The device of claim 17, wherein the at least one magnet is an electromagnet driven by the power source.

20. The device of claim 17, wherein the actuator is a switch configured to turn the power source on and off.
